(19) United States
(12) Patent Application Publication
(10) Pub. No.: US 2020/0356399 A1
(43) Pub. Date: Nov. 12, 2020

(54) VIRTUAL CONTROL UNIT

(71) Applicant: dSPACE digital signal processing and control engineering GmbH, Paderborn (DE)

(72) Inventors: Ulrich KIFFMEIER, Paderborn (DE); Markus SUEVERN, Paderborn (DE); Stuart Michael CHURCH, Paderborn (DE)

(73) Assignee: dSPACE digital signal processing and control engineering GmbH, Paderborn (DE)

(21) Appl. No.: 16/869,762

(22) Filed: May 8, 2020

(30) Foreign Application Priority Data
May 8, 2019 (DE) 10 2019 111 953.7

(51) Int. Cl. G06F 9/455; G06F 9/50

(52) U.S. Cl. CPC G06F 9/45558; G06F 2009/4557; G06F 2009/45562; G06F 9/5044

(57) ABSTRACT

A virtual control unit according to the AUTOSAR standard, including a service layer, an ECU abstraction layer, and a microcontroller abstraction layer. It is provided according to invention that the virtual control unit additionally comprises a hardware layer that is configured to simulate at least one hardware component. A virtual control unit is provided in this way which enables easy use of environment models for HIL tests and software testing and a fast simulation.

This nonprovisional application claims priority under 35 U.S.C. § 119(a) to German Patent Application No. 10 2019 111 953. 7, which was filed in Germany on May 8, 2019, and which is herein incorporated by reference.

### BACKGROUND OF THE INVENTION

### Field of the Invention

The present invention relates to a virtual control unit according to the AUTOSAR standard. Furthermore, the invention relates to a method for testing a control software of a control unit.

### Description of the Background Art

For functional tests of software of electronic control units (ECUs), hardware in the form of the control unit or in the form of a control unit prototype can basically be used and the control software can be tested in a real test, e.g., in real driving test. In such tests, however, in addition to the high costs and the very high expenditure of time, the lack of reproducibility is problematic due to the complex environmental conditions.

Furthermore, there are so-called hardware in the loop (HIL) tests in which the control unit is connected via inputs and outputs to a HIL simulator, wherein the HIL simulator simulates the real environment. The HIL simulator emulates the electrical signals from sensors and actuators that are read by the control unit. For example, in a HIL test of an internal combustion engine, the signals from crankshaft sensors and camshaft sensors are generated by an angular processing unit (APU) that is part of the HIL simulator hardware. The control unit in turn based on these signals generates sensor and/or actuator control signals by means of the control software; these in turn lead to a change in the electrical signals in the HIL simulator. The electrical signals emulated by the HIL simulator are generated by means of an environment model that maps the required signals, therefore, the entire environment. In addition to the closed loop control, the environment model also includes so-called disruptive models which affect the control loop, therefore, e.g., changing environmental conditions such as temperature, headwind, road unevenness, sensor signal errors such as electrical disturbances, and driver's steering movements (model). The controlled system that would be covered as a test track in a real driving test and thus would generate different electrical signals for the control unit is thus mapped in the environment model within the HIL simulation. In order to perform a HIL test, however, the development of a control unit must already be relatively advanced, because the control unit is connected via its hardware to the HIL simulator.

Hardware-independent software tests are required to enable earlier testing of the control software, for example, at a development time when no control unit hardware is yet available. Virtual electronic control units, also called V-ECUs, have become established for this purpose. A real control unit is emulated in a simulation scenario by means of a virtual control unit. A virtual control unit thus does not yet contain the control unit hardware intended for this purpose, but is formed of the control software of a real control unit and modules for connecting the control unit software to a simulation platform. In order to create virtual control units that are as realistic as possible and to check the software by reproducible tests, a virtual control unit can be created based on the control software of the real control unit. In this case, of course, some components of the control software of the real control unit have to be adapted to the virtual environment of the simulation platform.

However, the result here is that the connections or interfaces of a real control unit and a virtual control unit to an environment model are different, and thus the reuse of environment models for early software tests using virtual control units and HIL tests is made more difficult. Thus far, a virtual control unit in the computer for simulation is connected to various components, such as virtual sensors, actuators, and control unit networks. The virtual sensors, actuators, and/or control unit networks, therefore, the virtual hardware components, are integrated into the environment model as a hardware component model. For example, a virtual sensor is integrated as a sensor model into the environment model. Thus, the environment model for a HIL test of the internal combustion engine cannot be reused directly for the software test by means of the virtual control unit but it has to be expanded with simulations of crankshaft sensor and camshaft sensors, therefore, with the crankshaft sensor model or the camshaft sensor model, in order to adapt it to the interface of the virtual control unit. Thus, the environment models for HIL tests can be used only with difficulty for software tests with the use of virtual control units and vice versa.

Furthermore, the integration of the sensor models and/or actuator models into the environment model has the result that the entire simulation slows down considerably at high calculation rates of the sensor models, which may be necessary for a high accuracy, because due to the integration into the environment model, the environment model as well is calculated with the high calculation rate. For the simulation of sensors, calculation rates in the microsecond range may be necessary in order to precisely detect the times of signal changes. A complex step size control of the simulation would also be possible but prevents the reuse of the environment model under real-time conditions on the HIL simulator.

### SUMMARY OF THE INVENTION

It is therefore an object of the present invention to provide a virtual control unit that avoids the disadvantages described above. In particular, a simple use of the environment models for HIL tests and software testing is to be made possible and the simulation is to be accelerated.

According to an exemplary embodiment of the invention, a virtual control unit is provided according to the AUTOSAR standard, comprising a service layer, an ECU abstraction layer, and a microcontroller abstraction layer, wherein the virtual control unit additionally comprises a hardware layer that is configured for the simulation of at least one hardware component.

The interfaces between software and hardware in a control unit form the register accesses of the microcontroller. All hardware components accessed by the microcontroller by means of such register accesses can be a hardware component within the context of the invention. Consequently, hardware components within the context of the invention are, for example, external sensors and actuators outside the control unit, sensors and actuators installed on the control unit board, and internal components of the microcontroller itself, e.g., an angular processing unit (APU).

AUTOSAR (AUTomotive Open System ARchitecture) is an open and standardized software architecture for electronic control units (ECUs), with the aim of using software in vehicles from different manufacturers and electronic components from different suppliers. The main concept of the AUTOSAR software architecture is the separation of hardware-independent application software and hardware-oriented basic software (BSW) using the software abstraction layer (runtime environment, RTE). This software architecture through the separation makes it possible that a component-oriented, hardware-independent software structure at the application level can be developed without specific knowledge of the hardware used or planned.

The basic software (BSW) within the AUTOSAR software architecture has the following layers, referred to as layers: service layer, ECU abstraction layer, and microcontroller abstraction layer (MCAL). The basic software is divided further into different basic software modules. The MCAL is the lowest layer of the basic software. In real control units, access to the microcontroller of the control unit is routed via the MCAL. The MCAL contains drivers with direct access to the internal peripheral devices of the microcontroller and supplies the other components of the basic software with microcontroller-independent values. The MCAL is thus a hardware-specific layer that ensures a standard interface to the basic software. When a virtual control unit, also called V-ECU, is created based on the control software of a real control unit, therefore, some modules of the MCAL must be replaced in order to enable a simulation in the virtual environment by means of a simulation platform instead of an execution on the real control unit hardware.

So far, in software tests using virtual control units, the hardware component models, thus, for example, the sensor models and actuator models, are integrated into the environment model in the simulation. The core of the invention is now to expand the virtual control unit with an additional layer, thus, an additional hardware layer, which is configured to simulate at least one hardware component. Thus, in a simulation, the virtual hardware components can be simulated directly in the context of the virtual control unit. The virtual hardware component is integrated into the hardware layer of the virtual control unit as a hardware-component model. For example, in a simulation of a sensor, the sensor can be simulated as a virtual sensor directly by the virtual control unit, wherein the virtual sensor is integrated as a sensor model into the virtual control unit. The sensor model or the hardware component model calculates the behavior for each input signal, i.e., the associated output value and thus the result of the hardware component simulation. This results in the same connections or interfaces of the virtual control unit to the environment model as with the real control unit. Thus, the use of the environment model of the HIL test for the software test by means of the virtual control unit and vice versa is also simplified.

Furthermore, the integration of the hardware component models, thus, for example, the actuator models and/or sensor models, makes it possible that the calculation rate of the hardware component model can be selected independently of the calculation rate of the environment model. A high calculation rate of the hardware component model, which is optionally selected for a high accuracy, thus has hardly any increasing effect on the total simulation time. Thus, the additional hardware layer enables a significant increase in simulation speed.

The hardware layer can comprise a plurality of hardware layer modules, which are designed in accordance with the AUTOSAR standard like a basic software module. As already mentioned, the AUTOSAR standard for the basic software stipulates that it is divided into different basic software modules. A module in this case is understood to be a functional unit of software. Because the hardware layer comprises multiple hardware layer modules and the hardware layer modules are each designed according to the AUTOSAR standard as a basic software module, the hardware layer modules can also be incorporated into the virtual control unit in the same way as the basic software modules. Furthermore, this has the result that the hardware layer modules can be configured like the basic software modules. Thus, libraries can be provided for the hardware component models from which the user can select a hardware component module. The user only has to integrate and configure it like a basic software module. It is therefore not necessary that the user models the functionality of the hardware component or that the user laboriously incorporates the simulated hardware component manually into the communication with the virtual control unit. The user only needs to configure a hardware layer module like a basic software module.

In this connection, according to a further example, it is provided that in each case a hardware layer module is configured to simulate a respective hardware component. Thus, by the specific incorporation of the hardware layer modules, it is possible to simulate exactly the hardware components that are relevant to the specific real control unit. For example, the control software of the control unit that is responsible for the control of an internal combustion engine is to be tested. The real control unit receives signals from a crankshaft sensor and a camshaft sensor. For the software test using the virtual control unit, a hardware layer module for simulating the crankshaft sensor and a further hardware layer module for simulating the camshaft sensor can thus be used selectively. The virtual crankshaft sensor and the virtual camshaft sensor are each integrated as a hardware component model, thus, as a crankshaft sensor model and as a camshaft sensor model, in the respective hardware layer modules of the virtual control unit. This design thus leads to a great modularity and flexibility, which in particular simplifies the application.

As already mentioned, the basic software is divided into multiple layers within the AUTOSAR software architecture, wherein one of these is the microcontroller abstraction layer (MCAL). In this context, it is provided in a preferred refinement of the invention that the microcontroller abstraction layer comprises a plurality of MCAL modules, wherein the MCAL modules are connectable to the hardware layer modules. A MCAL module enables hardware-specific access to the hardware of a microcontroller via a standardized interface. The MCAL modules encapsulate the characteristics of the microcontroller and realize various driver functions, e.g., for bus access and input/output accesses, so-called IO accesses. When the hardware layer modules are incorporated into the virtual control unit, the hardware layer modules are thus connected to the MCAL modules of the microcontroller abstraction layer. In particular, the same development process according to AUTOSAR is used for implementing the hardware layer modules as for the rest of the control unit software. This makes it easier for the user to implement or incorporate a corresponding hardware layer module in a virtual control unit.

When a hardware layer module is connected to a MCAL module, it can be provided that one hardware layer module each is connected to one MCAL module each, that in each case a hardware layer module is connected to multiple MCAL modules, or that multiple hardware layer modules are connected to the same MCAL module. Of course, any combination of the mentioned variants is also possible. Thus, there is a close interlinking of the hardware layer with the microcontroller abstraction layer. Since the microcontroller abstraction layer in the virtual control unit represents the interface to the simulation platform, the simulation of the hardware component is efficient and easy to use.

The hardware layer is designed such that events can be generated within the virtual control unit. Within the context of the invention, an event is understood to mean a point in time at which the normal program flow is interrupted. For example, a sensor event can be generated for a sensor as a simulated hardware component within the hardware layer. It is provided in particular in this regard that the event can be generated with a high temporal accuracy. This means in particular that the time stamp associated with this event has a high accuracy.

The hardware layer can be configured such that the hardware component can be simulated with a different calculation rate. During simulation, signals are generated by the simulated hardware component and these signals are processed by the virtual control unit. The exchange of the signals takes place at a predetermined frequency, which is also referred to as the calculation rate. In a simulation of the hardware component at a high calculation rate, i.e., at a high calculation rate of the hardware component model, the time interval between two consecutive points in time of the simulated process is short. For example, at a calculation rate of 50 kHz, the period length is 20 microseconds. For some simulated hardware components, such a high calculation rate of the hardware component model is necessary for a sufficient accuracy because the simulated process changes rapidly. For example, if engine control with a crankshaft sensor is to be simulated, the calculation rate of the crankshaft sensor model must be high enough to still provide realistic results at engine speeds of 6000 rpm. This is because during a period length of 20 microseconds one revolution of the crankshaft by 0.72 degrees still takes place, which is a significant value in relation to the injection timing (about 6 degrees before the top dead center). For other hardware components, moreover, a lower calculation rate of the hardware component model may be sufficient for a realistic result. In this respect, it is of great advantage for a versatile use of the virtual control unit that the hardware layer is configured such that the at least one hardware component can be simulated with a different calculation rate. In other words, this means that the calculation rate of the hardware component model can be freely selected.

In connection with a modular structure of the virtual control unit, it is provided according to a preferred refinement of the invention that the hardware layer is configured to simulate a plurality of hardware components, wherein the individual hardware components can be simulated simultaneously with different calculation rates. This is also important, especially with regard to the total time of the simulation. If, for example, two sensors are to be simulated as hardware components and for realistic results one sensor is simulated with a high calculation rate, the other sensor can nevertheless be simulated with a lower calculation rate. If this were not possible and both sensors had to be simulated with the same calculation rate, this would unnecessarily increase the simulation time. This is because a high calculation rate of the hardware component model also means that more calculation steps must be performed for a certain period of time of the simulated process.

To return to the example of engine control with a crankshaft sensor: to simulate the time span of the process, which corresponds to one revolution (360 degrees) of the crankshaft, 500 calculation steps must be performed at an engine speed of 6000 rpm (=10 ms per revolution) and a calculation rate of 50 kHz (period length of 20 microseconds). If all hardware component models, therefore, the sensor model of the second sensor as well, in which no such high calculation rate is necessary for realistic results, would have to be calculated using this calculation rate, more calculation steps than necessary would be carried out for the second sensor model. This would lead to a longer simulation time. Therefore, the fact that each individual hardware component model can be calculated with its own calculation rate independently of the other hardware component models has the overall result that the total time used by a simulation is not unnecessarily extended by the high calculation rates of individual simulated hardware components.

With regard to the simulation, it is provided according to a preferred refinement of the invention that the virtual control unit can be connected to an environment model for the simulation, wherein, during the simulation, the environment model calculation rate deviates from a calculation rate of a hardware component model. In the context of the invention, the term environment model also includes, e.g., the simulation of the route that would be traveled in a real driving test with a real control unit; therefore, the route and its characteristics, such as its gradient, generate signals that are processed by the real control unit. This is also mapped during the simulation. The environment model thus exchanges signals with the virtual control unit during the simulation. The correlations between the calculation rates of the individual hardware component models and the simulation time, explained in the previous section, also apply to the calculation rate of the environment model. In this respect, the deviation of the calculation rate of the environment model from the calculation rate of the hardware component model during the simulation has the result that the simulation time is not unnecessarily extended by the high calculation rates of individual simulated hardware components. This reduces the simulation time.

The virtual control unit can be connected to an environment model for the simulation, wherein, during the simulation, signals are exchanged at a physical level between the environment model and the virtual control unit. In particular, no TTL signals are exchanged between the environment model and the virtual control unit, thus, digital signals whose logic values are represented by electrical voltages. Instead, signals are exchanged between the environment model and the virtual control unit at the physical level, thus, for example, rotation rates in the degrees/second unit, or electrical voltage values in the volt unit. Thus, the same environment model as for a HIL test can be used for the test of a virtual control unit, because signals are also exchanged at the physical level in HIL tests.

With regard to a rate at which signals are transmitted between the environment model and the virtual control unit, the rate at which the signals are transmitted between the environment model and the virtual control unit can be less than or equal to the calculation rate of the environment model. It is therefore entirely possible that a hardware component with a high calculation rate is simulated within the virtual control unit, but the rate at which the signals from the environment model and the virtual control unit are exchanged during the simulation is lower. Thus, the simulation time can be greatly reduced.

The invention further relates to a method for testing a control software of a control unit, wherein the control software is incorporated into a virtual control unit operating according to the AUTOSAR standard, wherein the virtual control unit comprises a service layer, an ECU abstraction layer, and a microcontroller abstraction layer, and wherein the virtual control unit additionally comprises a hardware layer with which at least one hardware component is simulated.

The method of the invention enables a hardware-independent software test of the control software of the control unit. In a first step, the control software is incorporated into a virtual control unit operating according to the AUTOSAR standard. This can be done, for example, by replacing some MCAL modules of the control software of the control unit. The virtual control unit comprises an additional hardware layer with which at least one hardware component is simulated. In particular, the hardware layer of the virtual control unit is used to simulate a hardware component which can be connected to the real control unit and/or exchanges signals with it. Thus, if the real control unit can be connected, for example, to a camshaft sensor, the hardware component camshaft sensor is simulated in the method for testing the control software of the control unit. The method thus has the advantage that it enables particularly realistic and hardware-independent tests of the control software. Furthermore, the method can be used particularly easily because the virtual control unit has the same interfaces as the real control unit. Accordingly, the same environment models as in the HIL test can be used. The preferred refinements of the virtual control unit as described in the above sections also apply to the method for testing the control software of the control unit. The resulting technical effects and advantages can be gathered from the description of the virtual control unit.

The virtual control unit can be connected to an environment model. For a realistic test of the control software, the virtual control unit can be connected to an environment model. Due to the structure of the virtual control unit with the additional hardware layer, the same environment model can be used as in HIL tests. Furthermore, lower simulation times result with a high simulation accuracy.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows schematically a virtual control unit of the prior art; and

FIG. 2 shows schematically a virtual control unit according to an exemplary embodiment of the invention.

### DETAILED DESCRIPTION

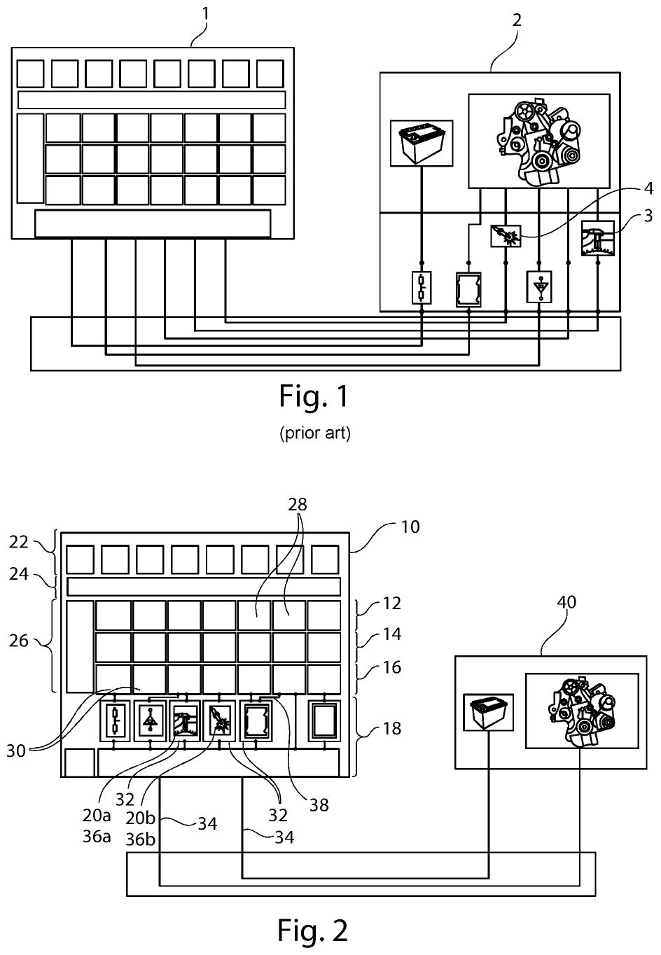

FIG. 1 shows schematically a virtual control unit 1, as known in the prior art. To simulate the engine control, virtual control unit 1 is connected to an environment model 2. Hardware component models 3, 4 are integrated into environment model 2 to simulate the hardware components. In the present prior-art example, a crankshaft sensor model 3 for simulating the crankshaft sensor and an actuator model 4 for simulating the injection valve actuator of the engine are integrated into environment model 2.

FIG. 2 schematically shows a virtual control unit 10 according to a preferred exemplary embodiment of the invention. Virtual control unit 10 is designed according to the AUTOSAR standard and comprises a service layer 12, an ECU abstraction layer 14, and a microcontroller abstraction layer 16. Furthermore, virtual control unit 10 comprises a hardware layer 18, wherein hardware layer 18 is configured to simulate at least one hardware component 20. Virtual control unit 10 is designed according to the AUTOSAR standard, so that application software layer 22 with the hardware-independent application software as well as software abstraction layer 24, which separates application software layer 22 from hardware-oriented basic software 26, are shown in FIG. 2. Service layer 12, ECU abstraction layer 14, and microcontroller abstraction layer 16 are part of basic software 26. Basic software 26 is formed of multiple basic software modules 28, wherein basic software modules 28 of microcontroller abstraction layer 16 are referred to as MCAL modules 30.

Virtual control unit 10 may be employed on a computer having an input, such as a key board, a processor, a memory, and a display for enabling modifications by a user. The virtual control unit 10 may also be shared to a plurality of computers in order for a plurality of users to use such in different tests. Upon conclusion of the testing, the final program is then provided to, for example, a vehicle control unit.

Furthermore, hardware layer 18 comprises a plurality of hardware layer modules 32, which like a basic software modules 28 are designed in accordance with the AUTOSAR standard. Each hardware layer module 32 is in each case configured to simulate a hardware component 20. In the exemplary embodiment shown in FIG. 2, a hardware layer module 32 for simulating a crankshaft sensor 20a is designed as a hardware component 20 and another hardware layer module 32 for simulating an injection valve actuator 20b as a hardware component 20. Hardware component model 36, which is calculated for the simulation of hardware component 20, is thus integrated into hardware layer module 32. In the present exemplary embodiment, therefore, crankshaft sensor model 36a and injection valve actuator model 36b are integrated into the respective hardware layer module 32. The integration of hardware component models 36 into virtual control unit 10 results in the same connections 34 of virtual control unit 10 as in the real control unit. The hardware layer 18 can also comprise at least partial data that was obtained directly or via an algorithm from a hardware component 20.

MCAL modules 30 of microcontroller abstraction layers 16 are connected to hardware layer modules 32. This is shown in FIG. 2 at connections 38, so that there is a close interconnection between hardware layer 18 and microcontroller abstraction layer 16. Virtual control unit 10 further is connected to an environment model 40 for the simulation.

An example is provided hereafter which sets forth the advantages of virtual control unit 10 of the invention compared with virtual control unit 1 of the prior art with regard to the shorter simulation time:

In this example, engine control is simulated with crankshaft sensor 20a. The calculation rate of crankshaft sensor model 36a must be high enough to still deliver realistic results at engine speeds of about 6000 rpm. With a resolution of crankshaft sensor 20a of 6 degrees per pulse, the following time intervals between two successive pulses result for a speed of 6000 rpm and for a speed of 300 rpm:

| Speed | Speed | Pulses per | Pulses per | Time interval between | |
|---|---|---|---|---|---|
| [rpm] | [rev/sec] | revolution | second | the pulses | |
| 6000 | 100 | 60 | 6000 | 166 | μs |
| 300 | 5 | 60 | 300 | 3.33 | ms |

To be able to resolve the timing of the pulses with sufficient accuracy, the period length of the sensor simulation should be ≤20 μs, wherein 20 μs at 6000 rpm still corresponds to a variable measurement error of about +/−0.7 degrees or of +/−12%.

The following table shows typical period lengths for each component in the signal chain, wherein the left column refers to a virtual control unit 1 according to the prior art, which is shown in FIG. 1, and the right column to the virtual control unit 10 of the invention from FIG. 2.

| | Virtual control unit 1 | Virtual control unit 10 | |
|---|---|---|---|
| | according to the prior art: | of the invention: | |
| | Integration of the sensor model | Integration of the sensor model | |
| | into the environment model | into the virtual control unit | |
| Component | Period length | Period length | |
| Simulation platform | 20 μs | 1 | ms |
| Engine model | 20 μs | 1 | ms |
| Sensor model | 20 μs | 20 | μs |

| | | |
|---|---|---|
| MCAL driver | 20 μs | event-based 166 μs . . . 3.33 ms |
| Control units tasks | Event-driven tasks | Event-driven tasks |
| | 166 μs-3.33 ms + other tasks | 166 μs-3.33 ms + other tasks |

In virtual control unit 1 according to the prior art, the sensor model for the crankshaft sensor together with the engine model forms a continuous system whose parts are simulated with a common calculation rate, therefore, with a common period length of 20 μs. The simulation platform of the virtual control unit triggers the environment model process with a period length of 20 μs. The prior-art virtual control unit must also be triggered with the same period length in order to process a sensor pulse that may be sent by the environment model. The entire data communication of all signals between the virtual control unit and the environment model takes place at this common calculation rate with a period length of 20 μs. In other words: in this case, therefore, not only the environment model must be calculated with a high calculation rate, but also the virtual control unit that samples the signals. The very complex inter-process communication must also take place with a period length of 20 μs. The effort for the process change alone is often more complex than the calculation of the sensor model. In summary, the high calculation rates result in a very long total simulation time.

In virtual control unit 10 of the invention, sensor model 36a of crankshaft sensor 20a is integrated into virtual control unit 10. This makes it possible to calculate individual sensor models independently of the other sensor models and independently of environment model 40 with a high calculation rate. Environment model 40 can be calculated depending on the engine time constants (inertial mass) with a typical period length of 1 ms, which reduces the effort for this process by a factor of 50 compared with the prior art. Within virtual control unit 10, only the relatively small sensor model 36a is calculated with the increased calculation rate with a period length of 20 μs. The additional software in virtual control unit 10 is calculated in periodic or event-driven tasks with the respective normal period length. The high calculation rate is thus limited to a small part of the virtual control unit process; that is, the total computing time hardly increases. The simulation platform also generates triggers at a common calculation rate with a period length of 166 μs to 1 ms. The data communication between the virtual control unit and the environment model also takes place at this calculation rate. Virtual control unit 10 of the invention is thus a few orders of magnitude more efficient, faster, and more flexible than virtual control unit 1 according to the prior art.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A virtual control unit according to the AUTOSAR standard, comprising:
a service layer;
an ECU abstraction layer;
a microcontroller abstraction layer; and
a hardware layer that is configured for the simulation of at least one hardware component.

2. The virtual control unit according to claim 1, wherein the hardware layer comprises a plurality of hardware layer modules which are designed in accordance with the AUTOSAR standard, including a basic software module.

3. The virtual control unit according to claim 2, wherein at least one of the plurality of hardware layer modules is configured to simulate a respective hardware component.

4. The virtual control unit according to claim 2, wherein the microcontroller abstraction layer comprises a plurality of MCAL modules, wherein the MCAL modules are connectable to the hardware layer modules.

5. The virtual control unit according to claim 1, wherein the hardware layer is configured such that events are generated within the virtual control unit.

6. The virtual control unit according to claim 1, wherein the hardware layer is configured such that the at least one hardware component is simulated with a different calculation rate.

7. The virtual control unit according to claim 1, wherein the hardware layer is configured to simulate a plurality of hardware components, wherein the individual hardware components are simulated substantially simultaneously with different calculation rates.

8. The virtual control unit according to claim 1, wherein the virtual control unit is connected to an environment model for the simulation, and wherein, during the simulation, a calculation rate of the environment model deviates from a calculation rate of a hardware component model.

9. The virtual control unit according to claim 1, wherein the virtual control unit is connected to an environment model for the simulation, and wherein, during the simulation, signals are exchanged at a physical level between the environment model and the virtual control unit.

10. The virtual control unit according to claim 8, wherein a rate at which the signals are transmitted between the environment model and the virtual control unit is less than or equal to the calculation rate of the environment model.

11. A method for testing a control software of a control unit, the method comprising:
incorporating the control software into a virtual control unit operating according to the AUTOSAR standard;
providing the virtual control unit with a service layer, an ECU abstraction layer, a microcontroller abstraction layer, and a hardware layer; and
simulating at least one hardware component via the hardware layer.

12. The method according to claim 11, wherein the virtual control unit is connected to an environment model.
